(19) United States
(12) Patent Application Publication
(10) Pub. No.: US 2005/0154974 A1
(43) Pub. Date: Jul. 14, 2005

(54) Method, apparatus and program storage device for inline controlling of row and column sets in tabular displays

(75) Inventors: Zhaohui Gao, West Linn, OR (US); Karen Ruth Kluttz, Raleigh, NC (US); Mark E. Molander, Cary, NC (US)

Correspondence Address: CRAWFORD MAUNU PLLC, 1270 NORTHLAND DRIVE, SUITE 390, ST. PAUL, MN, 55120, US

(73) Assignee: International Business Machines Corporation

(21) Appl. No.: 10/757,679

(22) Filed: Jan. 14, 2004

(51) Int. Cl. G06F 17/21

(52) U.S. Cl. 715/509; 715/503

(57) ABSTRACT

A method, apparatus and program storage device for inline controlling of row and column sets in tabular displays is disclosed. A macro controller provides a single control and is inline with the display and the user tasks. The macro controller allows the user to quickly switch between view configurations and thus provides an inline, e.g., it is not via a way off-to-the-side configuration panel, and very easy way to set the set of columns and set of rows that get displayed in a table with just one or two user actions.

### BACKGROUND OF THE INVENTION

1. Field of the Invention

This invention relates in general to tabular data presentation, and more particularly to a method, apparatus and program storage device for inline controlling of row and column sets in tabular displays.

2. Description of Related Art

Personal computer systems have attained widespread use for providing computer power to many segments of today's modem society. The impact of such development on the manner in which computing is done in business and consumer environments has been profound. With the wide spread use of personal computer systems access to data once maintained on an enterprise wide computer system became important to managers and ultimately line employees. Networks of personal computer systems grew up, with layered access through network servers to the enterprise systems or mainframes on which enterprise data is stored.

A familiar and effective information presentation form for certain types of structured information is that of an image of a table, also referred to herein as a “table image”. A “table” is generally ordered in a rectangular form of rows and columns with identifiers, such as labels, arranged at the periphery of the table. The intersection of a row and column in a table defines a data location, typically called a “cell”, and may include alphabetic and numeric character data or arithmetic operators or formulas. A table is distinguishable from various types of graphs that do not have all of the characteristics of the orderly, rectilinear arrangement of information found in a table. A popular application of a table image is the spreadsheet. Table images also may be used in a wide variety of application program contexts where the information structure includes linear elements and is organized in, or is capable of being organized in, an n-dimensional “array data structure”.

A common problem that exists with the presentation of data in a table image format of any size involves the presentation of large table images representing a large information structure when there is too much data for all of the data to be clearly presented in a table image that fits in the display area of the system display device. This phenomenon is referred to as the table's wide or extreme aspect ratio. The application program typically only presents a portion of the table image in the display area, and provides a function for the system user to scroll through the table image to reach portions not currently visible in the display area in order to access the data represented by the character images in the table cells. As scrolling brings new cells of the table image into view in the display area, the previously displayed cells, including row and column identifiers such as labels, typically disappear from the display area, and global context information, important for navigating around the table image and for understanding the data that is currently displayed, is lost from the systems user's view.

Users tend to more easily scroll from top-to-bottom or vertically of a document, rather than horizontally. Furthermore, users may be unaware, unless specifically prompted, that there is additional columnar information located to one side of a displayed window area. Additionally, maintaining an understanding of columns not displayed becomes more difficult as they are scrolled horizontally to one side and out of the display area. These problems can exist with both landscape and portrait orientation displays. A program which uses small windows, either by choice or because of a small display area being available as in a handheld client system, can ill afford displaying empty cells or fields, or display information that is irrelevant to the user. The display of an empty cell or irrelevant information introduces confusion for a user, in that elements, which may contain data of significance, may become displaced from the display area.

User interfaces for products continue to get richer from an exploding amount of data and attributes, and consequently more tabular all the time. However, as described above, adequately controlling the tabular presentation at the highest of levels is a burden for users. Sorting and filtering out a few rows is possible. However, quickly controlling sets of rows and columns is difficult.

Some presentation systems are optimized to particular pel-width panels, which translate to a maximum of 7 or 8 columns per table. In such presentation systems, deserving columns often can't quite make the cut for being displayed. Furthermore, there may be a desire to show up to 15 to 20 columns. Still, as described above, horizontal scrolling is a notoriously hard on users, especially when horizontal scrolling is performed in conjunction with vertical scrolling.

Another problem involves deciding how many rows to display in a table. Often, only a very minor subset of rows (e.g., 10 or 12) may be displayed. This requires the user to page through many rows at a time instead of scrolling all of them at once. Paging through rows can be very tedious.

It can be seen that there is a need for a method, apparatus and program storage device for inline controlling of row and column sets in tabular displays.

### SUMMARY OF THE INVENTION

To overcome the limitations in the prior art described above, and to overcome other limitations that will become apparent upon reading and understanding the present specification, the present invention discloses a method, apparatus and program storage device for inline controlling of row and column sets in tabular displays.

The present invention solves the above-described problems by providing a macro controller that is a single control and is inline with the display and the user tasks. The macro controller allows the user to quickly switch between view configurations and thus provides an inline, e.g., it is not via a way off-to-the-side configuration panel, and very easy way to set the set of columns and set of rows that get displayed in a table with just one or two user actions.

A program storage device in accordance with the principles of the present invention includes one or more programs of instructions executable by the computer to perform operations for controlling how data is presented in a tabular display, the operations comprising presenting a display to a user, providing a view configuration widget on the display and presenting a view configuration according to a setting of the view configuration widget.

In another embodiment of the present invention, a device providing for control of how data is presented in a tabular display is provided. The device includes a display device, a memory for storing data for presentation on the display device and a processor, coupled to the memory, the processor being configured for presenting a view configuration widget on the display device and presenting a view configuration according to a setting of the view configuration widget.

In another embodiment of the present invention, another device providing for control of how data is presented in a tabular display is provided. This device includes means for displaying an image, means for storing data for presentation on the means for displaying an image and means, coupled to the means for storing, for providing means for selecting a view configuration on the means for displaying an image and for presenting a view configuration according to a setting of the means for selecting a view configuration.

In another embodiment of the present invention, a method for controlling how data is presented in a tabular display is provided. The method includes presenting a display to a user, providing a view configuration widget on the display and presenting a view configuration according to a setting of the view configuration widget.

In another embodiment of the present invention, a graphical user interface for controlling how data is presented in a tabular display is provided. The graphical user interface includes a view configuration widget presented on a display device, the view configuration widget setting a configuration for viewing information on the display.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 illustrates a system for using a database according to an embodiment of the present invention;

FIG. 2 illustrates a table displaying storage system data;

FIG. 3 illustrates a table that implements row paging instead of scrolling;

FIG. 4 illustrates a matrix for an inline macro row and column set controller for a table according to an embodiment of the present invention;

FIG. 5a illustrates a table according to an embodiment of the present invention;

FIG. 5b illustrates a close-up view of the macro table control widget of FIG. 5a;

FIG. 6a illustrates a display that results after selecting the bottom-right quadrant of the macro table control widget according to an embodiment of the present invention;

FIG. 6b illustrates a close-up view of the macro table control widget of FIG. 6a;

FIG. 7 illustrates a drop-down selector for providing custom column and row filters according to another embodiment of the present invention; and

FIG. 8 illustrates a flow chart of a method for providing table row and column set control according to an embodiment of the present invention.

### DETAILED DESCRIPTION OF THE INVENTION

In the following description of the embodiments, reference is made to the accompanying drawings that form a part hereof, and in which is shown by way of illustration the specific embodiments in which the invention may be practiced. It is to be understood that other embodiments may be utilized because structural changes may be made without departing from the scope of the present invention.

The present invention provides a method, apparatus and program storage device for inline controlling of row and column sets in tabular displays. A macro controller provides a single control and is inline with the display and the user tasks. The macro controller allows the user to quickly switch between view configurations and thus provides an inline, e.g., it is not via a way off-to-the-side configuration panel, and very easy way to set the set of columns and set of rows that get displayed in a table with just one or two user actions.

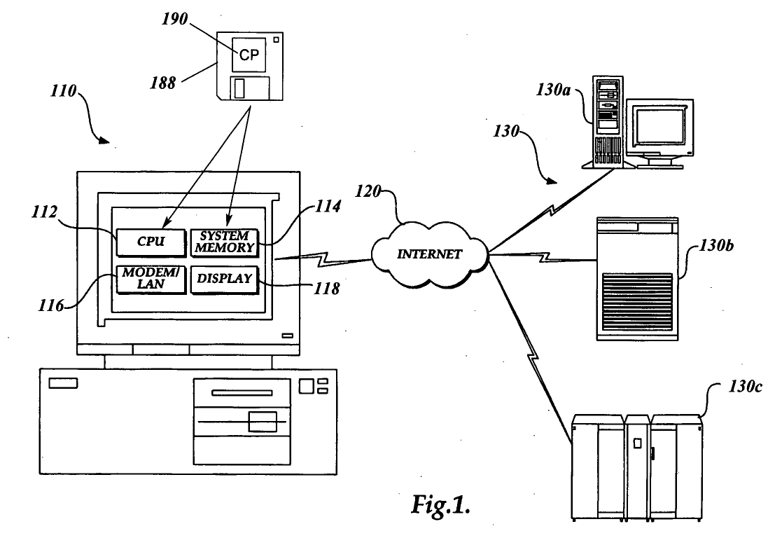

FIG. 1 illustrates a system 110 for using a database according to an embodiment of the present invention. In FIG. 1, a client process runs on a local or client computer 1 10 (hereinafter collectively called “client”) accesses and updates databases located, for example, on a remote or server computer 130 running a server process (hereinafter collectively called “server”). The clients and servers may be connected together through a network 120, such as the Internet. An example of a client process is a Web browser or spreadsheet program and an example of a server process is a Web server or database server.

A typical local (client) computer 110 for implementing the invention is a general-purpose computer, such as a conventional personal computer 110. As also shown in FIG. 1, personal computers include a central processing unit (CPU) 112, system memory 114, a modem or network card 116 for connecting the personal computer to the a network 120, and a display 118, plus other components not specifically shown in FIG. 1, such as a keyboard, mouse, etc. While an exemplary local (client) computer is a general purpose personal computer 110, as will be readily appreciated by those skilled in the art, other types and configurations of computers may be used without departing from the spirit and scope of the invention. While typical remote (server) computers 130 are university or corporate mainframe computers 130c, server computers may take the form of host personal computers 130a or dedicated workstations such as minicomputers 130b.

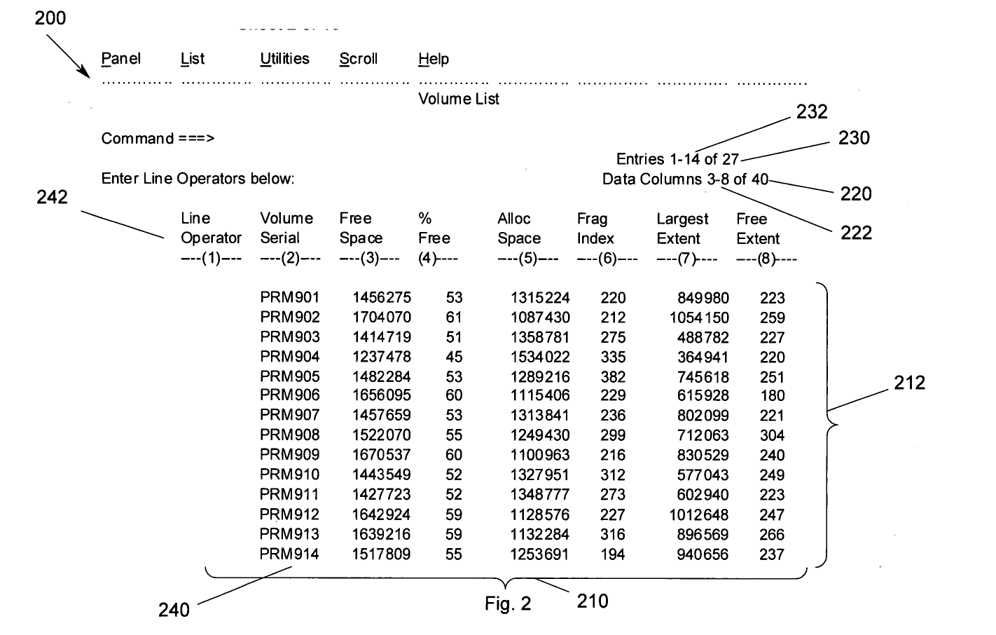

FIG. 2 illustrates a table 200 displaying storage system data. In FIG. 2, the display presents 8 columns 210 and 14 rows 212. However, such a table 200 usually has many more row and columns. For example, in FIG. 2 the display indicates that there are 40 columns 220 of which columns 3-8 of data 222 are shown (i.e., columns 1 and 2 are not data columns). FIG. 2 also indicates that there are 27 rows 230 of which only rows 1-14 232 are displayed. Thus, the user must scroll through the table image 200 to reach portions not currently visible in the display area in order to access the data represented by the character images in the table cells. As scrolling brings new cells of the table image into view in the display area, the previously displayed cells, including row and column identifiers such as labels 240, 242 typically disappear from the display area. The disappearance of labels 240, 242 removes any global context information that is important for navigating around the table image and for understanding the data that is currently displayed. While the present invention will be explained with reference to a table or spreadsheet, the present invention is not meant to be limited to setting the configuration views of only tables and spreadsheets, but rather is applicable to other displays.

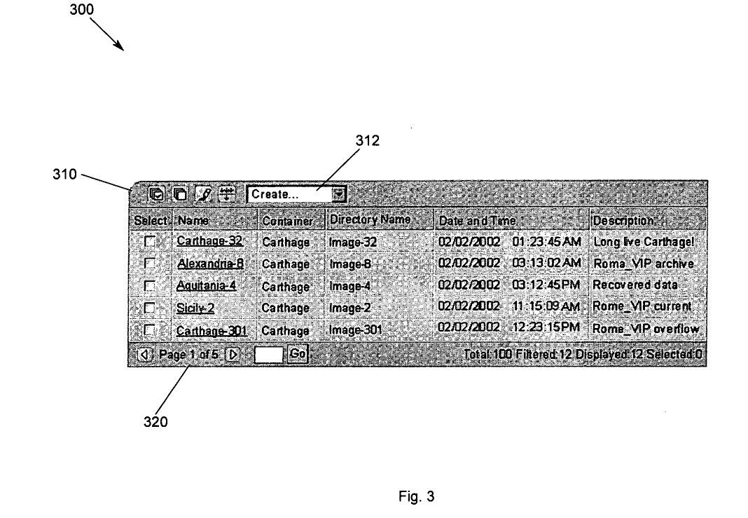

FIG. 3 illustrates a table 300 that implements row paging instead of scrolling. Another problem involves deciding how many rows to display in a table. Often, only a very minor subset of rows (e.g., 10 or 12) may be displayed. This requires the user to page through many rows at a time instead of scrolling all of them at once. The table of FIG. 3 includes a user interface for allowing a user to select one or more table actions 310. The user may then select an action 312 to perform on the selected images. A paging widget 320 is provided to navigate through the table 300. Nevertheless, navigating through table 300 using paging widget 320 can be very tedious.

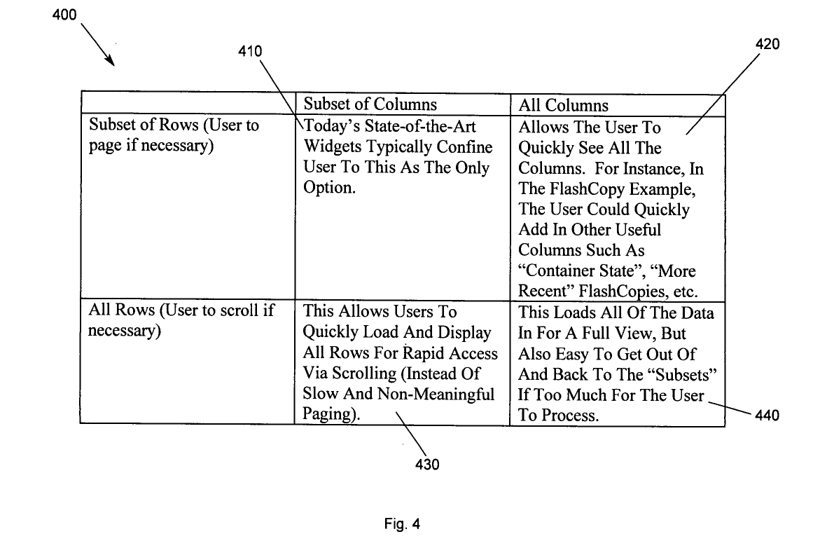

FIG. 4 illustrates a matrix 400 for an inline macro row and column set controller for a table according to an embodiment of the present invention. The functionality of the matrix may be implemented in a table widget to provide a simple method for users to quickly change the-table's row and column sets. In FIG. 4, a subset of rows and a subset of columns may be selected 410. This arrangement is the typical way data is displayed. Moreover, most state-of-the-art widgets confine users to this as the only option.

Another arrangement is to select all columns and a subset of rows 420. This arrangement allows the user to quickly see all the columns. However, the user would have to scroll or page through the rows to view additional data from rows not displayed. A third arrangement displays a subset of columns for all rows 430. This arrangement allows users to quickly load and display all rows for rapid access via scrolling, rather than requiring slow and non-meaningful paging. The last arrangement displayed in FIG. 4 involves the display of all columns and all rows 440. This arrangement loads all of the data in a full view. However, this view may present too much data for the user to handle and process. Those skilled in the art will recognize that the matrix 400 illustrated with reference to FIG. 4 is just one embodiment, and that a richer and more complex matrix could be provided within the scope of the present invention.

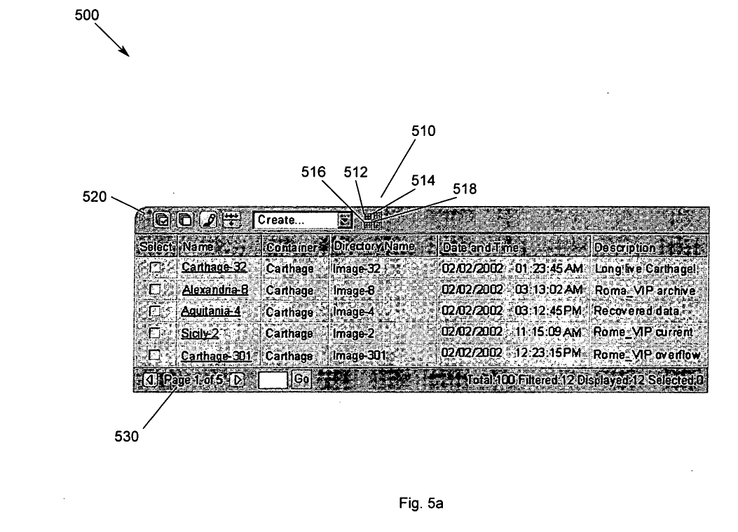

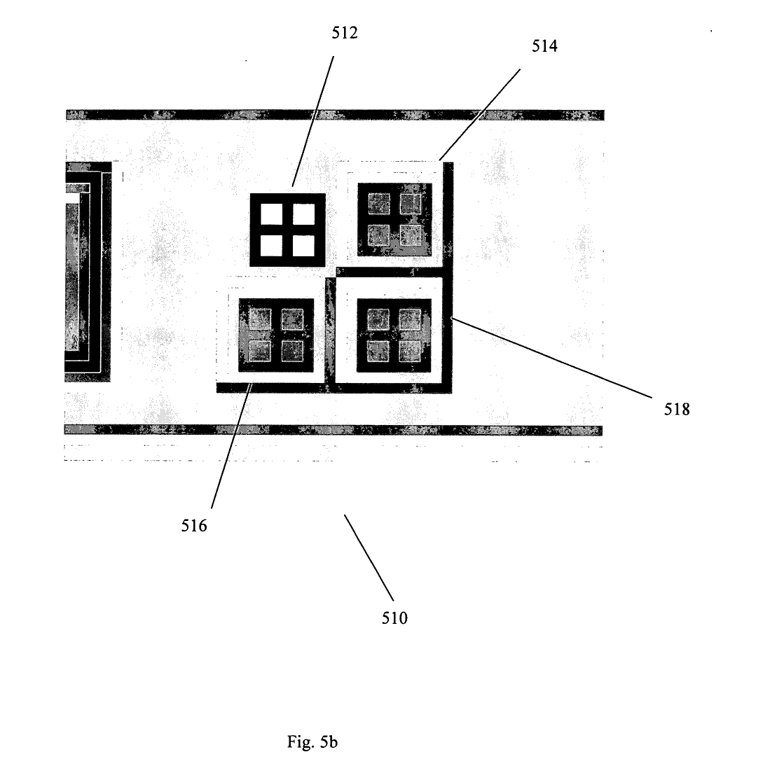

FIG. 5a illustrates a table according to an embodiment of the present invention. In the table 500 of FIG. 5a, an inline macro row and column set controller 510 is provided for quickly setting the sets of viewable columns and rows of the table. The inline macro row and column set controller 510 of FIG. 5a is arranged according to the matrix 400 described above with reference to FIG. 4. The table of FIG. 5a shows just the top-tier of columns and a reduced set of rows to start. This arrangement may be selected to be the default setting. The right-most control in the table's tool bar 520 is used to select the display. In the arrangement where a subset of rows and a subset of columns may be selected, the upper left portion 512 of the inline macro row and column set controller 510 is shown selected to provide the functionality corresponding to the upper left portion 410 of the matrix 400 of FIG. 4. The upper right portion 514 of the inline macro row and column set controller 510 may be selected to select all columns and a subset of rows. The lower left portion 516 of the inline macro row and column set controller 510 may be selected to display a subset of columns for all rows. The lower right portion 518 of the inline macro row and column set controller 510 may be selected to display all columns and all rows.

For example, if the user wants to see some columns that are not shown in FIG. 5a, and also wants all the rows to have more control, then via a single button click the user may select the bottom-right quadrant 518 of the inline macro row and column set controller 510. FIG. 5b illustrates a close-up view of the macro table control widget 510 of FIG. 5a. In FIG. 5b, the upper left portion 512 of the inline macro row and column set controller 510 is shown selected to provide the functionality corresponding to the upper left portion 410 of the matrix 400 of FIG. 4.

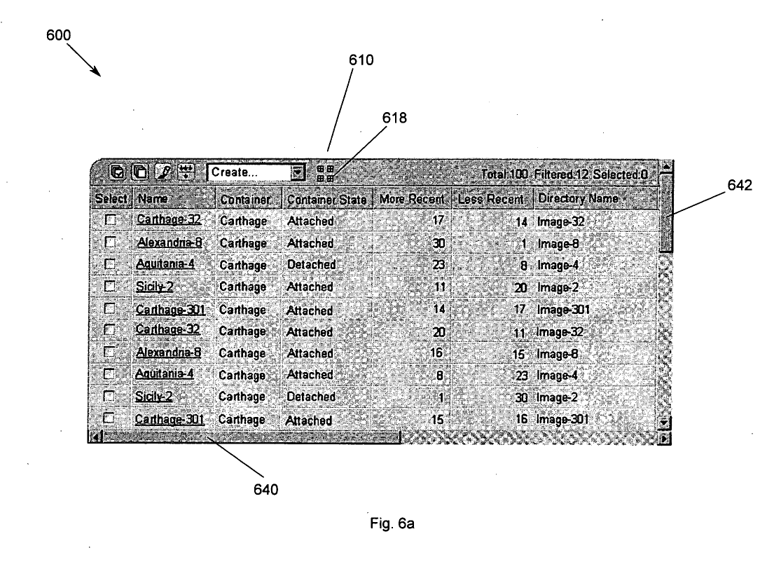

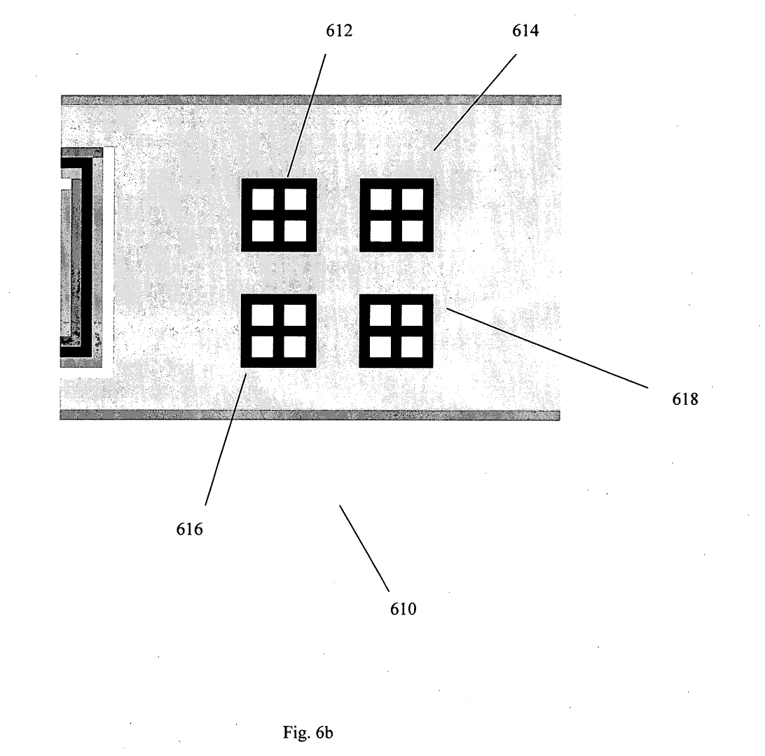

FIG. 6a illustrates a display 600 that results after selecting the bottom-right quadrant of the macro table control widget 610 according to an embodiment of the present invention. FIG. 6a illustrates that the paging widget 530 of FIG. 5a has been replaced with the scroll bars on the bottom 640 and on the right 642 of the table. Thus, all columns and all rows may be viewed by scrolling as provided by the selection of the bottom-right quadrant 618 of the inline macro row and column set controller 610. FIG. 6b illustrates a close-up view of the macro table control widget 610 of FIG. 6a, wherein the lower right portion 618 of the inline macro row and column set controller 610 may be selected to display all columns and all rows.

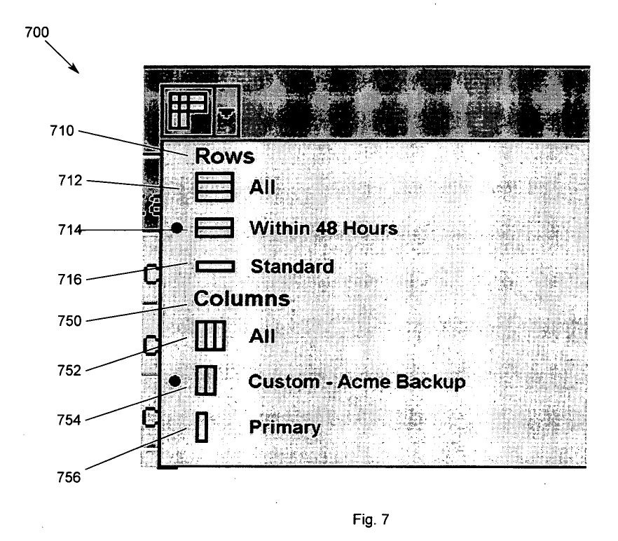

FIG. 7 illustrates a drop-down selector 700 for providing custom column and row filters according to another embodiment of the present invention. The drop-down selector 700 allows the user to customize column and row filters. Thus, rather than a simple 2×2 array of row and column options as provided by the inline macro row and column set controller 510, 610 shown in FIGS. 5-6, more quickly selectable options, such as the drop-down selector of FIG. 7, could be provided. The drop-down selector of FIG. 7 includes two radio button groups: one for row 710 and one for columns 750. The row set includes “All” 712, “Within 48 hours” 714, which, in this example, filters out the older FlashCopy Images that the user doesn't normally need to see, and “Standard” 716. The column set includes “All” 752, “Custom—Acme Backup” 754 that is one that the company (i.e., “Acme” in this example) has set up for their users with the job of backing up the Images, and which can also be thought of as a filtered subset of columns, and “Primary” 756.

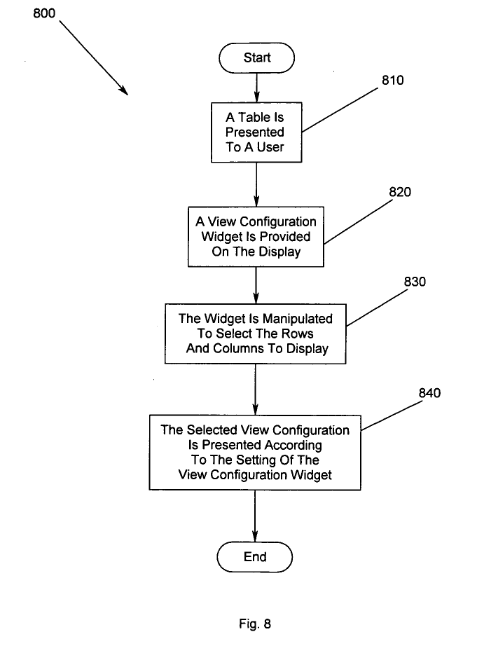

FIG. 8 illustrates a flow chart 800 of a method for providing table row and column set control according to an embodiment of the present invention. In FIG. 8, a table is presented to a user 810. A view configuration widget is provided on the display 820. The widget is manipulated to select the rows and columns to display 830. The selected view configuration is presented according to the setting of the view configuration widget 840.

The process illustrated with reference to FIGS. 1-8 may be tangibly embodied in a computer-readable medium or carrier, e.g. one or more of the fixed and/or removable data storage devices 188 illustrated in FIG. 1, or other data storage or data communications devices. The computer program 190 may be loaded into memory 114 to configure processor 112 for execution. The computer program 190 include instructions which, when read and executed by a processor 112 of FIG. 1, causes the devices to perform the steps necessary to execute the steps or elements of the present invention.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

1. A program storage device readable by a computer, the program storage device tangibly embodying one or more programs of instructions executable by the computer to perform operations for controlling how data is presented in a tabular display, the operations comprising:
presenting a display to a user;
providing a view configuration widget on the display; and
presenting a view configuration according to a setting of the view configuration widget.

2. The program storage device of claim 1, wherein the providing a view configuration widget comprises presenting a graphic user interface having a selector for setting a view configuration.

3. The program storage device of claim 2, wherein the presenting a graphic user interface having a selector further comprises providing 2-by-2 matrix of buttons, wherein selection of a first of the buttons causing a subset of columns and a subset of rows of a table to be displayed, selection of a second of the buttons causing all columns and a subset of rows of the table to be displayed, selection of a third of the buttons causing a subset of columns and all rows of the table to be displayed and selection of a fourth of the buttons causing all columns and all rows of the table to be displayed.

4. The program storage device of claim 1, wherein the providing a view configuration widget comprises providing a drop-down menu, the drop-down menu having items selectable by a user for setting a view configuration.

5. The program storage device of claim 4, wherein the providing a drop-down menu further comprises providing a menu of row selections and a menu of column selections.

6. The program storage device of claim 5, wherein the providing a menu of row selections further comprises providing a selection for displaying all of the rows.

7. The program storage device of claim 5, wherein the providing a menu of row selections further comprises providing a selection for displaying a predetermined configuration of rows.

8. The program storage device of claim 5, wherein the providing a menu of row selections further comprises providing a selection for displaying data relative to a predetermined time.

9. The program storage device of claim 5, wherein the providing a menu of column selections further comprises providing a selection for displaying all of the columns.

10. The program storage device of claim 5, wherein the providing a menu of column selections further comprises providing a selection for displaying only predetermined primary columns.

11. The program storage device of claim 5, wherein the providing a menu of column selections further comprises providing a custom selection for presenting predetermined columns.

12. A device providing for control of how data is presented in a display comprising:
a memory for storing data for display; and
a processor, coupled to the memory, the processor being configured for presenting a view configuration widget for display and presenting a view configuration according to a setting of the view configuration widget.

13. The device of claim 12, wherein the processor is configured to present a graphic user interface having a selector for setting a view configuration.

14. The device of claim 13, wherein the processor is configured to present a graphic user interface having a selector by providing 2-by-2 matrix of buttons, wherein selection of a first of the buttons causing a subset of columns and a subset of rows of a table to be displayed, selection of a second of the buttons causing all columns and a subset of rows of the table to be displayed, selection of a third of the buttons causing a subset of columns and all rows of the table to be displayed and selection of a fourth of the buttons causing all columns and all rows of the table to be displayed.

15. The device of claim 12, wherein the processor is configured to provide a view configuration widget by providing a drop-down menu, the drop-down menu having items selectable by a user for setting a view configuration.

16. The device of claim 15, wherein the processor is configured to provide a menu of row selections and a menu of column selections.

17. The device of claim 16, wherein the processor is configured to provide a selection for displaying all of the rows.

18. The device of claim 16, wherein the processor is configured to provide a selection for displaying a predetermined configuration of rows.

19. The device of claim 16, wherein the processor is configured to provide a selection for displaying data relative to a predetermined time.

20. The device of claim 16, wherein the processor is configured to provide a selection for displaying all of the columns.

21. The device of claim 16, wherein the processor is configured to provide a selection for displaying only predetermined primary columns.

22. The device of claim 16, wherein the processor is configured to provide a custom selection for presenting predetermined columns.

23. A device providing for control of how data is presented in a display, comprising:
means for storing data for display; and
means, coupled to the means for storing, for providing means for selecting a view configuration and for presenting a view configuration according to a setting of the means for selecting a view configuration.

24. A method for controlling how data is presented in a tabular display, comprising:
presenting a display to a user;
providing a view configuration widget on the display; and
presenting a view configuration according to a setting of the view configuration widget.

25. A graphical user interface for controlling how data is presented in a tabular display, comprising a view configuration widget presented on a display device, the view configuration widget setting a configuration for viewing information on the display.

26. The graphical user interface of claim 25, wherein the view configuration widget includes a selector for setting a view configuration.

27. The graphical user interface of claim 26, wherein the selector comprises a 2-by-2 matrix of buttons.

28. The graphical user interface of claim 25, wherein the view configuration widget includes a drop-down menu, the drop-down menu having items selectable by a user for setting a view configuration.

29. The graphical user interface of claim 28, wherein the view configuration widget includes a menu of row selections and a menu of column selections.
